(19) United States
(12) Patent Application Publication
(10) Pub. No.: US 2007/0059056 A1
(43) Pub. Date: Mar. 15, 2007

(54) IMAGE-FORMING APPARATUS

(75) Inventors: Tatsuomi Murayama, Tokyo (JP); Yuichiro Toyohara, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/469,249

(22) Filed: Aug. 31, 2006

(30) Foreign Application Priority Data
Sep. 13, 2005 (JP) 2005-265526

(51) Int. Cl. G03G 15/01

(52) U.S. Cl. 399/302

(57) ABSTRACT

An image-forming apparatus includes: a first image carrier for carrying a light toner image which is formed with a light toner; a first transfer member for electrostatically transferring the light toner onto an intermediate transfer body; a second image carrier for carrying a dark toner image which is formed with a dark toner having the same hue as that of the light toner and having a density higher than that of the light toner; a second transfer member for electrostatically transferring the dark toner image onto the intermediate transfer body; and a secondary transfer member for transferring the dark toner image and the light toner image electrostatically onto a recording medium together, in which the light toner has a volume mean particle diameter greater than that of the dark toner.

### BACKGROUND OF THE INVENTION

1. Field of the Invention

The present invention relates to an image-forming apparatus which primarily transfers a toner image from an image carrier onto an intermediate transfer body, and then secondarily transfers the toner image onto a recording medium, by using toners having the same hue and having different color densities, such as a dark magenta toner and a light magenta toner, or the like.

2. Description of the Related Art

In recent years, an electrophotographic type image-forming apparatus has used toners having the same hue and having the different color densities, such as dark magenta toner and light magenta toner, or the like, for extending a color-reproduction range.

A dark magenta toner image-forming unit and a light magenta toner image-forming unit are provided in this type of image-forming apparatus, so that a dark magenta toner image and a light magenta toner image are formed.

In the image-forming units, the toner images formed on a photoconductor drum are primarily transferred onto the intermediate transfer body at a primary transfer region sequentially and electrostatically. The toner images of the respective colors which have been primarily transferred onto the intermediate transfer body are secondarily transferred onto a recording medium by a secondary transfer member with a bias applied. Remaining toner which is not primarily transferred onto the intermediate transfer body and remains at the photoconductor drum is collected by a cleaner provided at the photoconductor drum. In addition, secondary transfer remaining toner which is not transferred onto the recording medium and remains at the intermediate transfer body is collected by a cleaner provided at the intermediate transfer body.

The toner images transferred onto the recording medium are conveyed to a fixer, and the toner images are heated and pressed on the recording medium to be fixed.

However, with the above-described image-forming apparatus, a considerable amount of the secondary transfer toner remains at the intermediate transfer body in the secondary transfer. Owing to this, toner images of desirable colors may not be formed on the recording medium.

Particularly, the former toner image which has been primarily transferred can pass the primary transfer region and become charged when the other latter toner image is primarily transferred. Due to this, the amount of electric charge of the first primary toner image becomes greater than that of the subsequent primary toner image. Accordingly, there may be a difference between the amount of electric charge of the first transferred toner image and that of the second transferred toner image.

If the difference between the amounts of electric charge is increased, it is difficult to apply biases suitable for both the first transferred toner image and the subsequently transferred toner image, to the secondary transfer member. In this way, the amount of secondary transfer toner remaining may be increased.

### SUMMARY OF THE INVENTION

The present invention provides an image-forming apparatus which uses toners having the same hue and having different densities so as to form toner images with desirable colors on a recording medium while the toner remaining after secondary transfer is decreased.

In addition, the present invention provides an image-forming apparatus, which includes: a first image carrier for carrying a light toner image which is formed with a light toner; a first transfer member for electrostatically transferring the light toner image formed on the first image carrier onto an intermediate transfer body; a second image carrier for carrying a dark toner image which is formed with a dark toner having the same hue as that of the light toner and having a density higher than that of the light toner; a second transfer member for electrostatically transferring the dark toner image formed on the second image carrier onto the intermediate transfer body which holds the light toner image; and a secondary transfer member for transferring the dark toner image and the light toner image formed on the intermediate transfer body electrostatically onto a recording medium together, in which the light toner has a volume mean particle diameter greater than that of the dark toner.

Further, the present invention provides another image-forming apparatus, which includes: an image carrier for carrying a light toner image formed with a light toner, and a dark toner image formed with a dark toner having the same hue as that of the light toner and having a density higher than that of the light toner; a transfer member for primarily transferring the light toner electrostatically onto an intermediate transfer body, and also primarily transferring the dark toner image onto the intermediate transfer body which holds the light toner; and a secondary transfer member for secondarily transferring the light toner and the dark toner electrostatically onto a recording medium together, in which the light toner has a volume mean particle diameter greater than that of the dark toner.

With this configuration, the particle diameter of the formerly primarily transferred toner image is increased. Since toner having large particles is hard to charge, the amount of electric charge to be applied to the toner when passing the primary transfer region can be decreased. In addition, in order to prevent the image quality being impaired due to the usage of large-particle toner, the particle diameter of the light toner, of which image deterioration is less noticeable, is increased.

In this way, the difference between the amounts of electric charge of the toner images can be decreased, and toner images having the desired colors can be formed on the recording medium.

Further features of the present invention will become apparent from the following description of exemplary embodiments with reference to the attached drawings.

### BRIEF DESCRIPTION OF THE DRAWINGS

FIG. 1 is a schematic cross-sectional view showing an image-forming apparatus according to a first embodiment.

FIG. 2 is an illustration showing the relationship between a dark toner and a light toner in terms of application amounts and optical densities of the toners.

FIG. 3 is an illustration showing an image output signal with respect to an image input signal when a light magenta toner image and a light cyan toner image are formed.

FIG. 4 is an illustration showing an image output signal with respect to an image input signal when a dark magenta toner image and a dark cyan toner image are formed.

FIG. 5 is an illustration showing an image output signal with respect to an image input signal when a yellow toner image and a black toner image are formed.

FIG. 6 is an illustration schematically showing the toner images formed on an intermediate transfer belt when secondary transfer efficiency is measured.

FIG. 7 is an illustration showing amounts of secondary transfer remaining toners with respect to secondary transfer biases when the volume mean particle diameter of a dark magenta toner and a light magenta toner is 5 μm.

FIG. 8 is an illustration showing amounts of secondary transfer remaining toners with respect to secondary transfer biases when the volume mean particle diameter of the dark magenta toner is 5 μm, and that of the light magenta toner is 7 μm.

FIG. 9 is a schematic cross-sectional view showing an image-forming apparatus according to a second embodiment.

### DESCRIPTION OF THE EMBODIMENTS

Embodiments of the present invention will be described below in detail.

### First Embodiment

An embodiment of the present invention will be described below in detail with reference to the drawings.

General Configuration of Image-Forming Apparatus

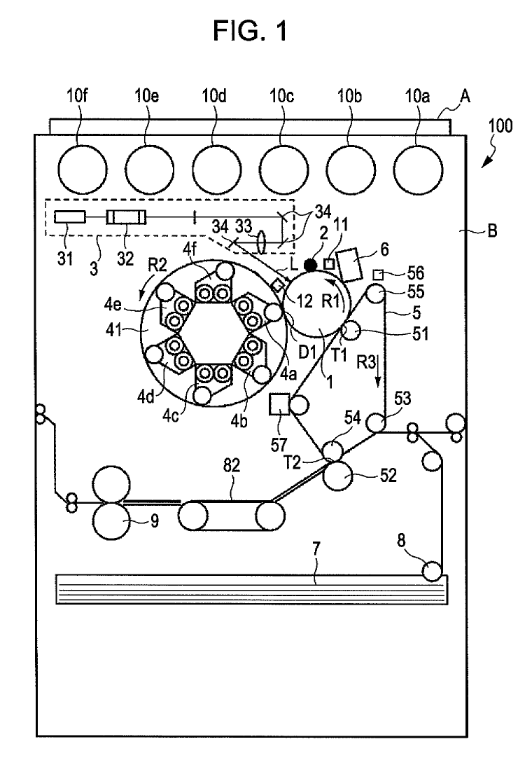

An image-forming apparatus according to the present embodiment shown in FIG. 1 is a full-color image-forming apparatus which primarily transfers a toner image formed on a photoconductor drum (image carrier) 1 onto an intermediate transfer belt (intermediate transfer body) 5, and then secondarily transfers the toner image onto a recording medium.

The image-forming apparatus according to the present embodiment includes one photoconductor drum 1 and six developing devices (developer or toner image-forming devices) 4 which develop electrostatic images formed on the photoconductor drum 1. The six developing devices 4 are filled with toners of light cyan, light magenta, dark magenta, dark cyan, yellow and black, respectively.

Accordingly, toner images of the light cyan, light magenta, dark magenta, dark cyan, yellow, and black, which are formed on the photoconductor drum 1, are primarily transferred onto the intermediate transfer belt 5 to be superimposed on each other. Then, the toner images are secondarily transferred onto the recording medium, collectively.

FIG. 1 is a schematic cross-sectional view showing an image-forming apparatus 100 according to the present embodiment.

The image-forming apparatus 100 includes a reader section A for reading an original document and a printer section B for forming an image based on image data.

In the reader section A, the original document is placed on an original-document glass plate (not shown), and is exposed to and scanned by an exposure lamp (not shown). Then, a reflected optical image of the original document is condensed at a full-color CCD sensor (not shown) by a lens (not shown) to acquire an image signal. The image signal is image processed by a video processing unit (not shown) via an amplifying circuit (not shown), and then sent to the printer section B.

The printer section B forms an image on the basis of the image signal sent from the reader section A. Note that the image-forming apparatus 100 can also form an image on the basis of an image signal sent from a computer or a facsimile in addition to the image signal sent from the reader section A.

The image signal sent from the reader section A is converted into color signals which correspond to the colors of the light magenta, light cyan, yellow, dark magenta, dark cyan, and black, respectively, by a signal converter (not shown) provided at the printer section B. The color signals are stored in a storage unit (not shown).

Firstly, a toner image of the light magenta which is the first color is formed.

On the basis of the color signal of the light magenta stored in the storage unit, a laser optical system (exposure unit) 3 emits laser light L on the photoconductor drum 1 which rotates in a direction of an arrow R1 FIG. 1.

The surface of the photoconductor drum 1 is evenly charged to have negative polarity by a primary charging device (primary transfer unit) 2 prior to the emitting of the laser light L. The surface of the photoconductor drum 1 is exposed to and destaticized by a pre-exposure lamp 11 before it is charged by the primary charging device 2.

When the laser light L on the basis of the color signal of the light magenta impinges on the photoconductor drum 1, which is evenly charged, an electrostatic image of the light magenta is formed on the photoconductor drum 1.

The six developing devices 4 are held by a rotary developing device holder 41. When the rotary developing device holder 41 rotates in a direction of an arrow R2 in FIG. 1, the developing device 4 is moved to a position (development position D1) facing the photoconductor drum 1, so that the electrostatic image can be developed.

The rotation of the rotary developing device holder 41 allows a light magenta developing device 41a, which is moved to the development position D1, to develop an electrostatic image of the light magenta, so that the toner image of the light magenta is formed on the photoconductor drum 1. At this time, the light magenta toner is charged to have negative polarity due to the developing device 4a.

The light magenta toner image on the photoconductor drum 1 is transferred (primarily transferred) onto the intermediate transfer belt 5 by a primary transfer roller (primary transfer unit) 51 when the light magenta toner image reaches a primary transfer region T1 where the photoconductor drum 1 is in contact with the intermediate transfer belt 5. At this time, a primary transfer bias (positive polarity) which is opposite to the polarity of the toner is applied from a primary transfer bias supply (not shown) to the primary transfer roller 51.

Light magenta toner which is not transferred onto the intermediate transfer belt 5 and remains at the photoconductor drum 1 is collected by a photoconductor drum cleaner 6.

Subsequently, a toner image of the light cyan, which is the second color, is formed in the same manner as that of the first-color toner image of the light magenta.

On the basis of a color signal of the light cyan, an electrostatic image is formed on the photoconductor drum 1.

By the rotation of the rotary developing device holder 41, a light cyan developing device 4b having light cyan toner is moved to the development position D1. The light cyan developing device 4b develops the electrostatic image, so that a light cyan toner image is formed on the photoconductor drum 1. The light cyan toner image is transferred by the primary transfer roller 51 so as to be superimposed on the light magenta toner image on the intermediate transfer belt 5 at the primary transfer region T1. At this time, the primary transfer bias (positive polarity) which is opposite to the polarity of the toner is applied to the primary transfer roller 51.

In the same manner, a yellow toner image of the third color, a dark magenta toner image of the fourth color, a dark cyan toner image of the fifth color, and a black toner image of the sixth color are formed on the photoconductor drum 1. Then, the images are sequentially transferred to the intermediate transfer belt 5 so as to be superimposed on the intermediate transfer belt 5.

The toner images of the above-mentioned six colors transferred onto the intermediate transfer belt 5 are collectively transferred onto a recording medium by a secondary transfer roller (secondary transfer unit) 52 at a secondary transfer region T2 where the secondary transfer roller 52 is in contact with the intermediate transfer belt 5. At this time, a secondary transfer bias is applied from a secondary transfer bias supply (not shown) to the secondary transfer roller 52. The secondary transfer bias (positive polarity) is opposite to the polarity of the toner.

The recording medium is housed in a recording medium housing 7, and is supplied to the secondary transfer region T2 by a supplier 8.

Remaining toner which is not transferred onto the recording medium during the secondary transfer process and which remains on the intermediate transfer belt 5 is collected by an intermediate transfer belt cleaner 57 which can move into contact with and away from the intermediate transfer belt 5.

The recording medium on which the toner images are transferred is conveyed to a fixer 9 by a conveyor belt 82. The fixer 9 includes a pair of rollers which are biased towards one another, and a heater (not shown). When the recording medium with the toner image transferred passes the fixer 9, the recording medium is heated and pressed between the rollers, so that the toner images are fixed on the recording medium.

Now, components of the image-forming apparatus will be described below in detail.

The photoconductor drum 1 rotates in the direction of the arrow R1 in FIG. 1 by a driver (not shown). The photoconductor drum 1 has a conductive base layer, and a photoconductive layer is provided thereon.

The photoconductor drum 1 may use an organic photosensitive member or an amorphous silicon photosensitive member. In this embodiment, the organic photosensitive member is used.

The primary charging device 2 evenly charges the surface of the photoconductor drum 1 to have a predetermined polarity by applying a bias from a primary charge bias supply (not shown).

The primary charging device 2 may be a corona charging device or a roller charging device.

In this embodiment, the primary charging device 2 employs a charging roller of contact charging type.

The charging roller has an elastic layer made of urethane foam with carbon dispersed therein, on a metal core of the charging roller. In addition, the surface of the elastic layer is coated with fluorocarbon resin.

The charging roller is pressed to the photoconductor drum 1 with a predetermined pressure applied by a presser (not shown), and is rotated along with the rotation of the photoconductor drum 1. A bias in which a direct voltage (−350 to −500 V) is superimposed on an alternating voltage (1000 Hz frequency and 1400 V amplitude) is applied to the charging roller by the primary charge bias supply. The application of the primary transfer bias, the primary charging device 2 evenly charges the photoconductor drum 1 to be approximately −500 V.

Incidentally, the direct voltage of the bias to be applied is based on the measurement result of an electric potential sensor 12 which measures an electric potential of the charged surface of the photoconductor drum 1, and is controlled by a controller (not shown), so that the photoconductor drum 1 is charged to have a desirable electric potential.

The laser optical system 3 is provided on the downstream of the primary charging device 2 in the rotation direction of the photoconductor drum 1. On the basis of the color signal stored in the storage unit, a light-emitting element 31 emits the laser light L. The laser light L is reflected by a rotatable polygon mirror 32, passes a lens 33, is reflected by reflection mirrors 34, and then impinges on the photoconductor drum 1. When the laser light L impinges on the charged photoconductor drum 1, an electrostatic image corresponding to the color signal is formed.

The six developing devices 4 are provided, and are filled with the toners of light magenta, light cyan, yellow, dark magenta, dark cyan and black, respectively. The six developing devices 4 are held by the rotary developing device holder 41. When the rotary developing device holder 41 rotates in the direction of the arrow R2, the developing device 4 which develops the electrostatic image on the photoconductor drum 1 is moved to the development position D1.

The developing device 4 of this embodiment uses a so-called two-component developing system. In the developing device 4, a toner and a carrier are mixed and the toner is friction charged by the carrier to have negative polarity.

The developing device is filled with two-component developer in which the toner and the carrier are mixed.

The toner contains coloring resin particles including biding resin, a coloring agent, and other additive if necessary; and coloring particles in which an external additive such as colloidal silica fine powder is externally added. The toner is negative-charged polyester resin.

The toner is manufactured by polymerizing or grinding. The volume mean particle diameter of the manufactured toner is controlled to be uniform by selecting with a mesh, or by other method.

The volume mean particle diameter may be 5 to 8 μm. In this embodiment, the volume mean particle diameter of the toners of the light magenta and light cyan is 7 μm, while that of toners of the dark magenta, dark cyan, yellow and black is 5 μm. The method of measuring the volume mean particle diameter of the toners will be described later.

The light cyan and the dark cyan have the same hue and have different reflection densities. The light magenta and the dark magenta have the above-stated correlation. The method of measuring the reflection density and the hue of the toner will be described later.

Hereinafter, the light cyan and light magenta are collectively referred to as a “light toner”, while the dark magenta, dark cyan, yellow and black are collectively referred to as a “dark toner”.

The use of the light toner in addition to the dark toner may increase the color variations of the toner images to be formed.

According to the dark toner of this embodiment, an amount of the coloring agent is controlled such that the reflection density of the toner becomes 1.4 when a mass per unit area (hereinafter, referred to as the “application amount”) of the toner on a sheet of high-quality paper is 0.5 mg/cm². According to the light toner, an amount of the coloring agent is controlled such that the reflection density of the toner becomes 0.7 when the application amount of the toner on the sheet of the high-quality paper is 0.5 mg/cm².

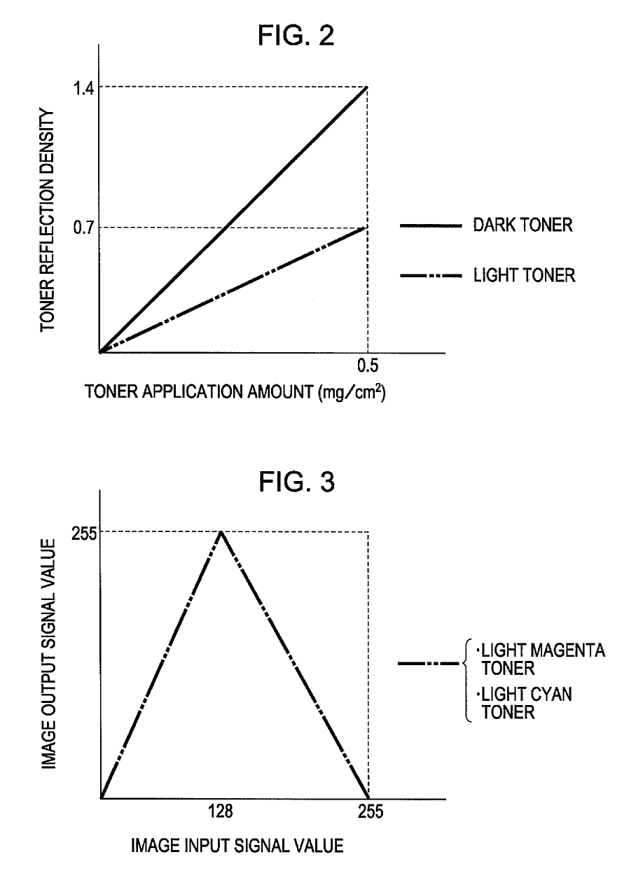

FIG. 2 shows a comparison between the light toner and the dark toner in terms of the application amount on the sheet of the high-quality paper, and the reflection density. Both the light toner and the dark toner increase in the reflection density along with the increase in the application amount. When the application amount is 0.5 mg/cm², the reflection amount of the light toner is 0.7, while that of the dark toner is 1.4.

The carrier (magnetic particle) may use surface oxidized or unoxidized metal, such as iron, nickel, cobalt, manganese, chrome, or rear earth, or an alloy of these, oxide ferrite, or the like. The method of manufacturing the carrier may be polymerizing. In addition, the volume mean particle diameter of the carrier may be 20 to 50 μm, and more particularly, the diameter may be 30 to 40 μm, while the resistivity thereof may be 10⁷ Ω·cm or higher, and more particularly, the resistivity may be 10⁸ Ω·cm or higher. In this embodiment, the carrier in which the volume mean particle diameter is 35 μm, the resistivity is 5×10⁹ Ω·cm, and the magnetization volume is 200 emu/cc, is used.

In the vicinity of the laser optical system 3 in the printer section B, toner housings 10a to 10f which house the toners of the respective colors are provided. If the toners in the developing devices 4a to 4f are used, the toners are supplied from the toner housings 10a to 10f as necessary.

Incidentally, a toner image formed on the photoconductor drum under a given condition is transferred onto the intermediate transfer belt 5, and then is detected by a detection sensor 56. According to the detection result of the detection sensor 56, the amounts of the toners to be supplied to the developing devices 4a to 4f are controlled, so that the weight ratio (TD ratio) of the toner and the carrier in each of the developing devices 4a to 4f is kept to fall in a predetermined value.

The TD ratio is represented by T/(T+D) where T(g) is a weight of the toner in the developing device 4 and D(g) is a weight of the carrier. In this embodiment, the TD ratio is kept to be approximately 8% in each of the developing devices 4a to 4f.

The signal converter converts an image signal (image input signal) sent from the reader section A into a signal (image output signal) to be sent to the laser optical system 3 to form an electrostatic image.

With the image-forming apparatus according to this embodiment, the relationship between the image input signal and the image output signal is different corresponding to the color of the toner image to be formed.

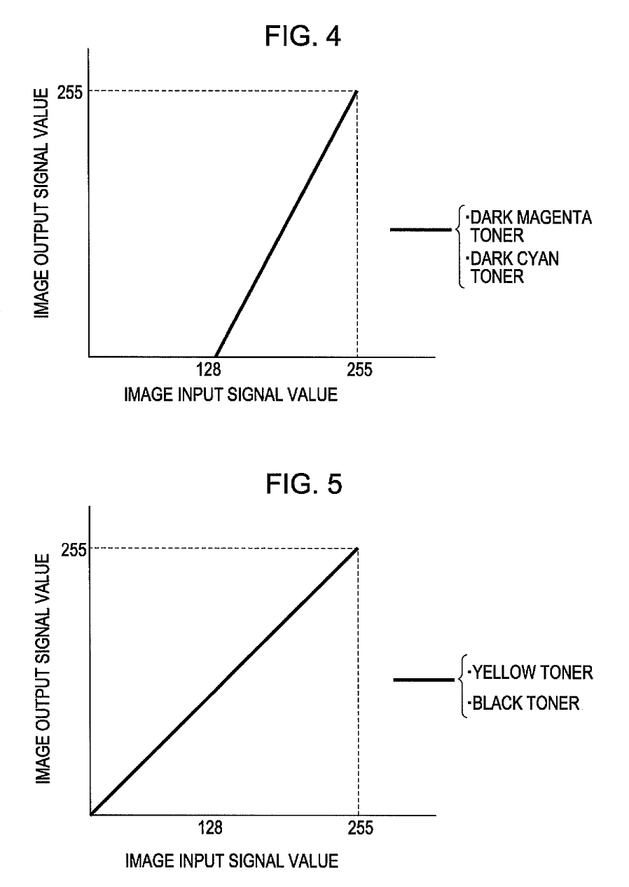

FIG. 3 is an illustration showing the relationship between an image output signal value and an image input signal value with respect to the light magenta toner and the light cyan toner. A line shown in FIG. 3 represents both the light magenta toner and the light cyan toner. FIG. 4 is an illustration showing the relationship between an image output signal value and an image input signal value with respect to the dark magenta toner and the dark cyan toner. A line shown in FIG. 4 represents both the dark magenta toner and the dark cyan toner. FIG. 5 is an illustration showing the relationship between an image output signal value and an image input signal value with respect to the yellow toner and the black toner. A line shown in FIG. 5 represents both the yellow toner and the black toner.

The intermediate transfer belt 5 is an endless belt, and is supported by a driving roller 55, a plurality of driven rollers 53, and a secondary transfer inner roller 54. When the driving roller 55 is rotated by the driver (not shown), the intermediate transfer belt 5 rotates in a direction of an arrow R3 in FIG. 1.

The material of the intermediate transfer belt 5 may be resin such as polyimide or polycarbonate. In this embodiment, polyimide is used.

In addition, the thickness of the intermediate transfer belt 5 may be approximately 0.1 to 2 mm. In this embodiment, the thickness is 0.2 mm.

The resistance of the intermediate transfer belt 5 is controlled to a desirable value by using a resistance regulating agent such as carbon. The resistance may be 1×10⁶ to 1×10¹³ Ω·cm in terms of volume resistivity.

In this embodiment, the volume resistivity is 1×10⁸ Ω·cm.

The primary transfer roller 51 is positioned at the primary transfer region T1 to face the photoconductor drum 1 with the intermediate transfer belt 5 interposed therebetween. The primary transfer roller 51 is rotatably supported by a supporting member (not shown).

The primary transfer roller 51 may be a member provided with an elastic layer on a core metal thereof. In this embodiment, the elastic layer uses polyurethane formed rubber.

The hardness (Asker C) of the elastic layer is 10. In addition, the resistance regulating agent is dispersed in the elastic layer, and the volume resistivity thereof is controlled to approximately 1×10⁶ Ω·cm.

When the primary transfer bias supply (not shown) applies the bias (positive polarity) which is opposite to the polarity of the toner image, the toner image on the photoconductor drum 1 is transferred onto the intermediate transfer belt 5. The direct voltage of +500 to +750 V is applied to the primary transfer roller 51.

The secondary transfer roller 52 is positioned at the secondary transfer region T2 to face the secondary transfer inner roller 54 with the intermediate transfer belt 5 interposed therebetween. The secondary transfer roller 52 is rotatably supported by a supporting member (not shown).

The secondary transfer roller 52 may be a member provided with an elastic layer on a core metal thereof. In this embodiment, the elastic layer uses polyurethane formed rubber.

The hardness (Asker C) of the elastic layer is 10. In addition, the resistance regulating agent is dispersed in the elastic layer, and the volume resistivity thereof is controlled to approximately 1×10⁷ Ω·cm.

When the secondary transfer bias supply (not shown) applies the bias (positive polarity) which is opposite to the polarity of the toner image, the toner image on the intermediate transfer belt 5 is transferred onto the recording medium. +1 to +3 kV is applied to the secondary transfer roller 52.

The intermediate transfer belt cleaner 57 is provided so as to move into contact with and away from the intermediate transfer belt 5. That is, while the toner image on the photoconductor drum 1 is primarily transferred onto the intermediate transfer belt 5, the intermediate transfer belt cleaner 57 is away from the intermediate transfer belt 5. When the primary transfer is completed, the intermediate transfer belt cleaner 57 comes into contact with the intermediate transfer belt 5.

The intermediate transfer belt cleaner 57 uses a polyurethane blade member with the durometer A hardness being 75 and the thickness being 2 mm.

The rollers for the fixer 9 are made of metal and are covered with a fluorocarbon rubber such as PTFA on the surface (which has mold release properties).

Relationship Between Particle Diameter of Toner and Secondary Transfer Efficiency

As described above, this embodiment uses the six-color toners.

The volume particle diameter of the toners of the first-color light magenta and the second-color light cyan is 7 μm, while that of the third-color dark magenta, the fourth-color dark cyan, the fifth-color yellow, and the sixth-color black is 5 μm.

The experimental result of the relationship between the particle diameter of each toner and the secondary transfer efficiency is shown in Table 1.

As shown in Table 1, “particle-diameter combination 1” as this embodiment represents the secondary transfer efficiency of each toner image of the first to sixth colors when the volume mean particle diameter of the toners of the first and second colors is 7 μm, while that of the third to sixth colors is 5 μm.

Meanwhile, “particle-diameter combination 2” as a comparison represents the secondary transfer efficiency when the volume mean particle diameter of each toner of the first to sixth colors is 5 μm.

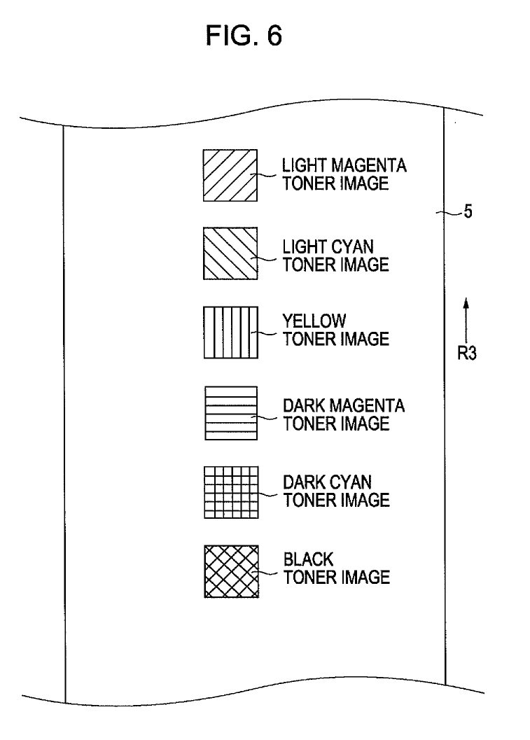

Note that, as shown in FIG. 6, the secondary transfer efficiency is measured by forming each toner image of the respective colors on the intermediate transfer belt 5 in a line along the advancing direction of the intermediate transfer belt 5. Then, the mass per unit area of each toner image on the intermediate transfer belt 5 is compared with that on the recording medium after the secondary transfer.

The secondary transfer efficiency in Table 1 is expressed by the following expression.
(secondary transfer efficiency)=[(mass of toner image per unit area on recording medium)]/(mass of toner image per unit area on intermediate transfer belt)]×100

TABLE 1

| | Order of Color | | | | | |
|---|---|---|---|---|---|---|
| | First | Second | Third | Fourth | Fifth | Sixth |
| | Color | Color | Color | Color | Color | Color |
| Particle- | 90.0% | 91.0% | 90.3% | 91.8% | 93.2% | 95.2% |
| Diameter | | | | | | |
| Combination 1 | | | | | | |
| Particle- | 88.0% | 89.0% | 90.2% | 91.5% | 93.1% | 95.0% |
| Diameter | | | | | | |
| Combination 2 | | | | | | |

As shown in Table 1, in the “particle-diameter combination 1”, all toner images attained the secondary transfer efficiencies of 90% or higher.

On the other hand, in the “particle-diameter combination 2”, the secondary transfer efficiencies of the toner images of the first and second colors are below 90%.

TABLE 2

| | | Order of Color | | | | | |
|---|---|---|---|---|---|---|---|
| | | First | Second | Third | Fourth | Fifth | Sixth |
| | | Color | Color | Color | Color | Color | Color |
| Particle- | Particle- | 5 μm | 5 μm | 5 μm | 5 μm | 5 μm | 5 μm |
| Diameter | Diameter | | | | | | |
| Combination | Amount of | 20 | 20 | 19 | 18 | 18 | 17 |
| 2 | Electric | | | | | | |
| | Charge | | | | | | |

Unit of Amount of Electric Charge: μC/g

Table 2 shows an amount of electric charge per unit area of each toner image of the respective colors on the photoconductor drum 1, according to the “particle-diameter combination 2”.

The toner image on the intermediate transfer belt 5 is charged with the primary transfer bias which is applied to the primary transfer roller 51 each time when passing the primary transfer region T1. Accordingly, the toner image which is first transferred passes the primary transfer region T1 for larger number of times. In addition, the toner image which is first primarily transferred receives higher electric charge in the secondary transfer.

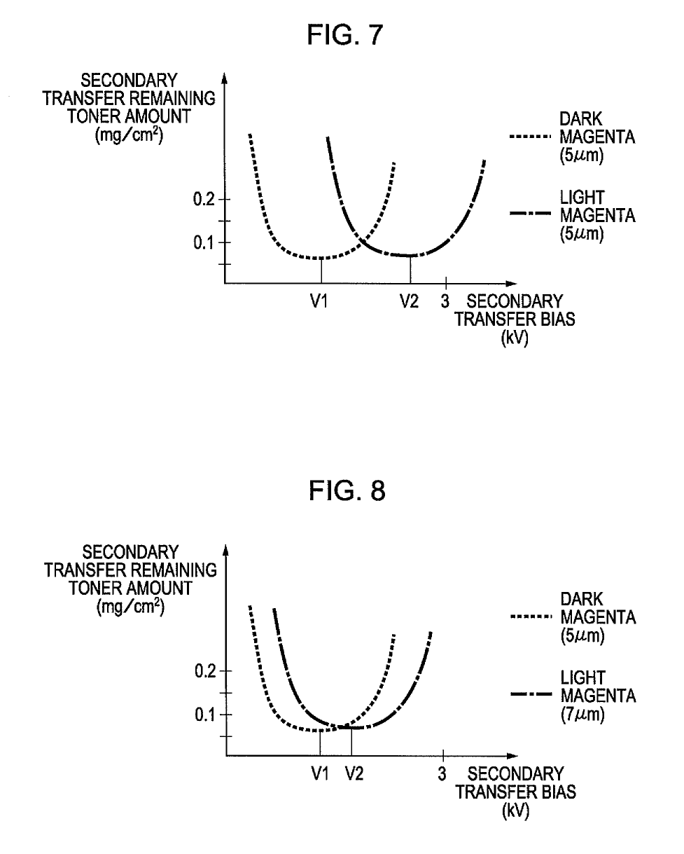

FIG. 7 represents the relationship between the voltage of the secondary transfer bias and the amount of the secondary transfer remaining toner, according to the “particle-diameter combination 2”. FIG. 7 shows the relationship between the first-color light magenta toner image and the fourth-color dark magenta toner image.

In the relationship shown in FIG. 7, there is a large difference between a secondary transfer bias V1 which allows the amount of the secondary transfer remaining toner of the dark magenta toner image to be the least; and a secondary transfer bias V2 which allows the amount of the secondary transfer remaining toner of the light magenta toner image to be the least. Namely, it is difficult to make both the dark magenta toner image and the light magenta toner image exhibit good secondary transfer efficiencies together. This is possibly because the difference between the amount of electric charge of the dark magenta toner and that of the light magenta toner becomes large in the secondary transfer due to the charge applied to the light magenta toner image when passing the primary transfer region T1.

In addition, in order to prevent the image quality being deteriorated due to the usage of the large-particle toner, the particle diameter of the light toner, of which image deterioration is less noticeable, is increased.

TABLE 3

| | | Order of Color | | | | | |
|---|---|---|---|---|---|---|---|
| | | First | Second | Third | Fourth | Fifth | Sixth |
| | | Color | Color | Color | Color | Color | Color |
| Particle- | Particle- | 7 μm | 7 μm | 5 μm | 5 μm | 5 μm | 5 μm |
| Diameter | Diameter | | | | | | |
| Combination | Amount of | 24 | 24 | 29 | 28 | 28 | 27 |
| 1 | Electric | | | | | | |
| | Charge | | | | | | |

Unit of Amount of Electric Charge: μC/g

Table 3 shows an amount of electric charge per unit area of each toner image of the respective colors on the photoconductor drum 1, according to the “particle-diameter combination 1”. The amounts of electric charge of the toner images of the first and second colors are decreased relative to that of the third to sixth colors. This is possibly because the contact area of the toner and the carrier is decreased if the particle diameter of the toner is increased, so that the amount of electric charge applied due to the contact charging with the carrier is decreased.

In addition, this is possibly because the area to be charged at the primary transfer region T1 is decreased if the particle diameter of the toner is increased, so that the amount of electric charge applied to the toner per unit weight when passing the primary transfer region T1 is decreased.

In the relationship shown in FIG. 8, there is a small difference between a secondary transfer bias V1 which allows the amount of the secondary transfer remaining toner of the dark magenta toner image to be minimized; and a secondary transfer bias V2 which allows the amount of the secondary transfer remaining toner of the light magenta toner image to be minimized.

On the photoconductor drum 1, the amounts of electric charge of the toner images of the first and second colors are decreased relative to that of the third to sixth colors. However, the number of times each toner image of the first and second colors passes the primary transfer region T1 are grater than the number of times each toner image of the third to sixth colors passes the primary transfer region T1. Accordingly, when the sixth-color toner image has been primarily transferred, and the secondary transfer is performed, the differences of the amounts of electric charge among the six-color toners become small. This is possibly because the difference between the secondary transfer bias which allows the amount of the secondary transfer remaining toner of the first-color light magenta toner to be the least; and that of the sixth-color black toner to become small.

Therefore, the secondary transfer remaining toner of the dark magenta toner image and that of the light magenta toner image can be decreased together, thereby realizing good secondary transfer efficiency.

As described above, the volume mean particle diameter of the toner for forming the toner image which is formerly primarily transferred is set larger than that of the toner for forming the toner image which is latterly primarily transferred, thereby attaining the good secondary transfer efficiency. Accordingly, the toner images of the desirable colors can be formed on the recording medium.

Now, the method of measuring the amount of electric charge per unit mass of the toner of the toner image on the photoconductor drum will be described below.

As a measurement device, E-SPART MODEL EST-II, manufactured by Hosokawa Micron Corporation was used. The measurement condition included that Field Voltage is 100 (V) and Particle Density is 1 (g/cm³), and the mean amount of electric charge per unit mass was assumed as the amount of electric charge per unit mass of the toner of the toner image.

In addition, the volume mean particle diameter of the toner employed according to the present invention was measured as follows.

The measurement was carried out within a range between 0.4 to 60 μm, by using laser scan type particle size distribution measuring apparatus (CIS-100, manufactured by GALAI Co., Ltd.) for the toner having the volume mean particle diameter of 3 μm or more. The sample for the measurement was prepared as follows. First, 0.2 ml of a surfactant (alkylbenzene sulphonate) is added to 100 ml of water and 0.5 to 2 mg of the toner for the measurement was added thereto. Then, this was dispersed by ultrasonic disperser for 2 minutes, then 1 or 2 drops of the resulting sample were added to a cubic cell filled with water to nearly 80% containing a magnet stirrer.

The reflection density and the hue of the toner were measured as follows.

The toner images of the respective colors as shown in FIG. 6 are formed on the intermediate transfer belt 5, and then are secondarily transferred on a sheet of CLC paper (80 g/m²) manufactured by CANON HANBAI KABUSHIKI KAISHA. The secondary transfer allows the toner image with a predetermined application amount to be formed on a sheet of CLC paper (80 g/m²).

Then the toner images are fixed on the sheet of CLC paper (80 g/m²) by using the fixer of the image-forming apparatus. At this time, the fixing condition employs one used for usually forming an image by using the sheet of CLC paper (80 g/m²). Then, each toner image formed on the sheet of CLC paper (80 g/m²) is measured with X-Rite 504 manufactured by X-Rite, Inc. (optical system condition: incident angle is 45° and light-receiving angle is 0°, and filter condition: status A). Accordingly, the density and the hue of the toner can be obtained.

Note that when the optical density and the hue of the toner is compared among the different toners, the application amount of each toner image formed on the sheet of CLC paper (80 g/m²) is set to 0.5 g/cm², and then the optical density and the hue of each toner is measured.

### Second Embodiment

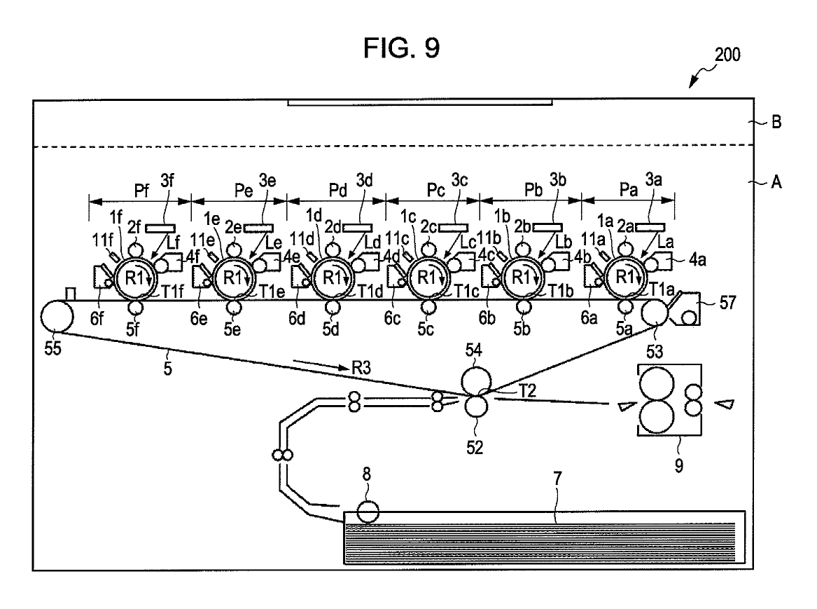

FIG. 9 is a second embodiment of the present invention. The image-forming apparatus according to the present embodiment employs tandem system where image-forming units Pa to Pf each of which is provided with the photoconductor drum 1 are disposed along the intermediate transfer belt 5 which rotates in the direction of the arrow R2.

Note that like numerals will refer to like parts which have equivalent configurations and effects as that used in the image-forming apparatus according to the first embodiment, and the description thereof will be omitted. In addition, the volume mean particle diameter, density and hue of each toner are equivalent to that of the first embodiment, and the measurement of the amount of electric charge per unit mass of each toner employs the same method as that of the first embodiment.

General Configuration of Image-Forming Apparatus

In FIG. 9, toner images of the light magenta, light cyan, yellow, dark magenta, dark cyan and black are formed at Pa, Pb, Pc, Pd, Pe, Pf. Then the formed toner images are transferred (primarily transferred) onto the intermediate transfer belt 5 in a superimposed manner. The toner images are collectively transferred (secondarily transferred) onto the recording medium.

A light magenta toner image-forming unit Pa and a light cyan toner image-forming unit Pb are disposed sequentially from the upstream in the rotation direction of the intermediate transfer belt 5 toward the downstream. In addition, a yellow toner image-forming unit Pc, a dark magenta toner image-forming unit Pd, a dark cyan toner image-forming unit Pe, and a black toner image-forming unit Pf are disposed. Note that these toners have similar configurations except that the colors of the toner images to be formed are different.

The image-forming units Pa, Pb, Pc, Pd, Pe, Pf include processing units disposed around rotatable photoconductor drums 1a, 1b, 1c, 1d, 1e, if, respectively. Particularly, primary charging devices 2a, 2b, 2c, 2d, 2e, 2f, and developing devices 4a, 4b, 4c, 4d, 4e, 4f are so disposed. In addition, photoconductor drum cleaners 6a, 6b, 6c, 6d, 6e, 6f, and pre-exposure lamps 11a, 11b, 11c, 11d, 11e, 11f are provided. Further, primary transfer rollers 51a, 51b, 51c, 51d, 51e, 51f are provided at positions where the photoconductor drums 1 each are in contact with the intermediate transfer belt 5.

Now, an image-forming operation will be described below by using the light magenta image-forming unit Pa as an example. The rotatable photoconductor drum 1 is discharged by the pre-exposure lamp 11a, and then evenly charged to have negative polarity by the primary charging device 2a. The laser optical system 3a emits laser light La corresponding to the color signal to impinge on the charged photoconductor drum 1a, thereby forming an electrostatic image. The developing device 4a of the two-component system develops the electrostatic image by using the light magenta toner to form a light magenta toner image. The rotation of the photoconductor drum 1a allows the light magenta toner image on the photoconductor drum 1a to reach a primary transfer region T1a where the intermediate transfer belt 5 is in contact with the photoconductor drum 1a. When a bias (positive polarity) opposite to the polarity of the light magenta toner is applied to the primary transfer roller 5a at the primary transfer region T1a, the light magenta toner image is primarily transferred onto the intermediate transfer belt 5. Further, the toner remaining at the photoconductor drum 1a is removed by the photoconductor drum cleaner 6a.

Similarly to this, toner images are formed on other image-forming units Pb, Pc, Pd, Pe, Pf, respectively. Also, the toner images are primarily transferred onto the intermediate transfer belt 5 which moves in the direction of the arrow R2.

The recording medium housed in the recording medium housing 7 which is provided at a lower portion of the printer section B is supplied to the secondary transfer region T2 by the supplier 8, synchronously with the image formation.

When the bias (positive polarity) opposite to the polarity of the toner images is applied to the secondary transfer roller 52, the toner images on the intermediate transfer belt 5 are transferred onto the supplied recording medium. Further, the recording medium is conveyed to the fixer 9, so that the toner images are fixed on the recording medium by the fixer 9.

The toner which is not transferred onto the recording medium and remains at the intermediate transfer belt 5 is collected by the intermediate transfer belt cleaner 57.

Particle Diameter of Toner and Second Transfer Efficiency

In the present embodiment, the same toners as that of the first embodiment are used. Particularly, the volume mean particle diameter of the first-color light magenta toner and the second-color light cyan toner is 7 μm.

The volume mean particle diameter of the third-color yellow toner, fourth-color dark magenta toner, fifth-color dark cyan toner and sixth-color black toner is 5 μm.

Further, in the image-forming apparatus according to the present embodiment, the amount of electric charge per unit area of the toner image of the toner on the photoconductor drum 1 of each image-forming unit exhibits the following results, which is the same as the result of the first embodiment.

TABLE 4

| | Order of Color | | | | | |
|---|---|---|---|---|---|---|
| | First | Second | Third | Fourth | Fifth | Sixth |
| | Color | Color | Color | Color | Color | Color |
| Particle- | 7 μm | 7 μm | 5 μm | 5 μm | 5 μm | 5 μm |
| Diameter | | | | | | |
| Amount of | 24 | 24 | 29 | 28 | 28 | 27 |
| Electric | | | | | | |
| Charge | | | | | | |

Unit of Amount of Electric Charge: μC/g

Also in the image-forming apparatus according to the present embodiment, the toner image formerly primarily transferred on the intermediate transfer belt 5 is charged when passing other primary transfer regions located downstream in the rotation direction of the intermediate transfer belt 5.

Due to this, the amount of electric charge of the toner image first primarily transferred is increased, which may cause unevenness among the amounts of electric charge in the secondary transfer.

In the present embodiment, the amount of electric charge of the toner image which is first primarily transferred on the photoconductor drum 1 is decreased relative to that of the toner image which is latterly primarily transferred, by taking into account the charge applied to the former toner image when passing the primary transfer region T1 located on the downstream.

This decreases the difference among the amounts of electric charges of the toner images in the secondary transfer, and enables good secondary transfer.

In addition, the particle diameter of the toner of the toner image which is first primarily transferred is larger than that of the toner image which is latterly primarily transferred. This decreases the amount of electric charge applied when the toner image, which is formerly transferred, passes the primary transfer region T1, and enables good secondary transfer.

In this way, toner images with the desired colors can be formed on the recording medium.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the priority of Japanese Application No. 2005-265526 filed Sep. 13, 2005, which is hereby incorporated by reference herein in its entirety.

What is claimed is:

1. An image-forming apparatus comprising:
a first image carrier for carrying a light toner image which is formed with a light toner;
a first transfer member for electrostatically transferring the light toner image formed on the first image carrier onto an intermediate transfer body;
a second image carrier for carrying a dark toner image which is formed with a dark toner having the same hue as that of the light toner and having a density higher than that of the light toner;
a second transfer member for electrostatically transferring the dark toner image formed on the second image carrier onto the intermediate transfer body which holds the light toner image; and
a secondary transfer member for transferring the dark toner image and the light toner image formed on the intermediate transfer body electrostatically onto a recording medium together,
wherein the light toner has a volume mean particle diameter greater than that of the dark toner.

2. The image-forming apparatus according to claim 1, wherein the amount of electric charge per unit mass of the light toner on the first image carrier is less than that of the dark toner on the second image carrier.

3. An image-forming apparatus comprising:
an image carrier for carrying a light toner image formed with a light toner, and a dark toner image formed with a dark toner having the same hue as that of the light toner and having a density higher than that of the light toner;
a transfer member for primarily transferring the light toner electrostatically onto an intermediate transfer body, and also primarily transferring the dark toner image onto the intermediate transfer body which holds the light toner; and
a secondary transfer member for secondarily transferring the light toner and the dark toner electrostatically onto a recording medium together,
wherein the light toner has a volume mean particle diameter greater than that of the dark toner.

4. The image-forming apparatus according to claim 3, wherein the amount of electric charge per unit mass of the light toner is less than that of the dark toner on the image carrier.
